(19) United States
(12) Patent Application Publication
(10) Pub. No.: US 2011/0006746 A1
(43) Pub. Date: Jan. 13, 2011

(54) SOFT-START CIRCUIT AND METHOD FOR A SWITCHING REGULATOR

(75) Inventors: SHAO-HUNG LU, TAOYUAN CITY (TW); ISAAC Y. CHEN, JUBEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: RICHTEK TECHNOLOGY CORP., HSINCHU (TW)

(21) Appl. No.: 12/830,638

(22) Filed: Jul. 6, 2010

(30) Foreign Application Priority Data
Jul. 9, 2009 (TW) 098123189

(51) Int. Cl. G05F 1/10

(52) U.S. Cl. 323/288

(57) ABSTRACT

A soft-start circuit for a switching regulator includes a signal generator and a scaling circuit coupled to the signal generator. During soft-start, the signal generator provides a ramp signal for the switching regulator such that the output voltage of the switching regulator changes from a residual voltage toward a target level. When soft-start is triggered, the scaling circuit provides a scaling voltage depending on the residual voltage, to shift the level of the ramp signal and consequently shorten the soft-start time of the switching regulator.

### FIELD OF THE INVENTION

The present invention is related generally to a switching regulator and, more particularly, to a soft-start circuit and method for a switching regulator.

### BACKGROUND OF THE INVENTION

There are many systems equipped with a soft-start mechanism for smoother start, less start impact, and unlikely overload as well as over voltage to some elements thereof. The traditional soft-start approaches always softly start a system from zero voltage. However, at the output of the system, there may be residual charges as a result of previous operation and such residual charges lead to an output voltage of the system being not zero when the system just starts. In the traditional soft-start methods, it is first to discharge the charges residual at the output of the system before subsequent accumulation. Nevertheless, doing so not only waste the residual charges but also brings about the risk of damaging the circuit by excessive negative inductor current.

FIG. 1 is a systematic diagram of a switching regulator 10 capable of performing soft-start for the output voltage Vo from a residual voltage, and FIG. 2 is a waveform diagram of this switching regulator 10 to show the soft-start operation when the residual voltage is lower than a target level, in which waveform 30 represents the output voltage Vo, waveform 32 represents a ramp signal SS_Ramp, waveform 34 represents a feedback signal VFB, waveform 36 represents an enable signal EN, waveform 38 represents an enable signal Real_EN, waveform 40 represents a control signal Source_CTL, and waveform 42 represents a control signal Sink_CTL. In the switching regulator 10, a pair of serially connected switches 20 and 22 are switched by the control signals Source_CTL and Sink_CTL, respectively, to convert an input voltage Vin into the output voltage Vo for loads 24 and 26. During normal operation, the output voltage Vo is regulated at a certain target level. A sample circuit 28 samples the output voltage Vo to generate the feedback signal VFB for a negative input of an error amplifier 14. A multiplexer 12 selects either a reference voltage Vr or the ramp signal SS_Ramp applied to a positive input of the error amplifier 14. When the switching regulator 10 is started, such as at time t1, the enable signal EN turns into high level to enable the error amplifier 14. At the same time the multiplexer 12 provides the ramp signal SS_Ramp applied to the positive input of the error amplifier 14 for the switching regulator 10 enters soft-start. In such a case, since the output of the switching regulator 10 has a residual voltage lower than the target level, the feedback signal VFB is not zero. In the course where the ramp signal SS_Ramp increases from zero to the feedback signal VFB, such as during time t1 to time t2, the error amplifier 14 does not turn on the enable signal Real_EN and thereby a PWM controller 16 remains off. When the ramp signal SS_Ramp becomes equal to the feedback signal VFB, such as at time t2, the enable signal Real_EN turns to high level to trigger the PWM controller 16. Therefore, the PWM controller 16 generates the control signals Source_CTL and Sink_CTL according to the error signal Si provided by the error amplifier 14 to control the switches 20 and 22, causing the output voltage Vo to increase from the level of the residual voltage toward the target level. For preventing reverse current in an inductor L, a soft-start controller 18 blocks the control signal Sink_CTL and so keeps the switch 22 off for a period of time, such as between time t2 and time t3. The soft-start controller 18 determines whether or not to release the control signal Sink_CTL by detecting the ramp signal SS_Ramp. For example, the soft-start controller 18 does not release the control signal Sink_CTL until the soft-start ends or until the ramp signal SS_Ramp reaches a predetermined value, such as at time t3.

Although the switching regulator 10 eliminates waste of charges by allowing the output voltage Vo to start from the level of the residual voltage during soft-start while preventing reverse inductor current, it requires a relatively prolonged soft-start time Tss for the ramp signal SS_Ramp to increase to the level of the feedback signal VFB. In addition, since the switching regulator 10 can only provide the upward ramp signal SS_Ramp, when its output has a residual voltage higher than the target level, the effect of the soft-start deteriorates. FIG. 3 is a waveform diagram of the switching regulator 10 to illustrate the soft-start operation when the residual voltage is higher than the target level, in which waveform 44 represents the enable signal EN, waveform 46 represents the ramp signal SS_Ramp, waveform 48 represents the feedback signal VFB, waveform 50 represents the enable signal Real_EN, waveform 52 represents the control signal Source_CTL, and waveform 54 represents the control signal Sink_CTL. When the switching regulator 10 is started, the enable signal EN turns to high level to enable the error amplifier 14, such as at time t4. Meantime, the multiplexer 12 provides the ramp signal SS_Ramp applied to the positive input of the error amplifier 14, making the switching regulator 10 entry soft-start. In such a case, since the output of the switching regulator 10 has a residual voltage higher than the target level, the multiplexer 12 will switch the reference voltage Vr to the positive input of the error amplifier 14 when the ramp signal SS_Ramp reaches the level of the reference voltage Vr, such as at time t5. Because the feedback signal VFB is greater than the reference voltage Vr, the PWM controller 16 is not triggered. At this time, only by the time where the load current releases the residual charges at the output of the switching regulator 10 to make the feedback signal VFB slightly smaller than the reference voltage Vr, the enable signal Real_EN can turn into high level to trigger the PWM controller 16 to terminate the soft-start process. However, a very small load current causes an excessively prolonged soft-start time Tss.

U.S. Pat. No. 7,501,805 discloses a method that uses an upward ramp signal and a downward ramp signal together with a multiplexer for two-directional soft-start, giving desired soft-start effects even when the output voltage is higher than the target level. However, this method requires a multiplexer plus two signal generators to provide the upward and downward ramp signals, and thus consumes greater circuit area while still failing to improve the problem related to the long soft-start time.

Therefore, it is desired a soft-start circuit and method with a shortened soft-start time for a switching regulator.

### SUMMARY OF THE INVENTION

An object of the present invention is to provide a soft-start circuit and method for a switching regulator.

Another object of the present invention is to provide a soft-start circuit and method for reducing the soft-start time of a switching regulator.

A further object of the present invention is to provide a soft-start circuit with a reduced circuit area.

According to the present invention, a soft-start circuit for a switching regulator includes a signal generator and a scaling circuit. During soft-start, the signal generator provides a ramp signal such that the output voltage of the switching regulator changes from the level of a residual voltage toward a target level. When soft-start is triggered, the scaling circuit provides a scaling voltage for the signal generator depending on the residual voltage, to shift the level of the ramp signal and thereby reduce the soft-start time of the switching regulator.

According to the present invention, a soft-start method for a switching regulator includes providing a ramp signal such that the output voltage of the switching regulator changes from the level of a residual voltage toward a target level when soft-start is triggered, and obtaining a scaling voltage according to the residual voltage, by which scaling voltage the level of the ramp signal is shifted and the soft-start time of the switching regulator is reduced.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a systematic diagram of a conventional switching regulator;

FIG. 2 is a waveform diagram of the switching regulator shown in FIG. 1;

FIG. 3 is another waveform diagram of the switching regulator shown in FIG. 1;

FIG. 4 is a circuit diagram of a first embodiment according to the present invention;

FIG. 5 is a waveform diagram of the switching regulator shown in FIG. 4;

FIG. 6 is another waveform diagram of the switching regulator shown in FIG. 4;

FIG. 7 is a circuit diagram of a second embodiment according to the present invention;

FIG. 8 is a circuit diagram of an embodiment for the scaling circuit shown in FIGS. 4 and 7; and

FIG. 9 is a circuit diagram of another embodiment for the scaling circuit shown in FIGS. 4 and 7.

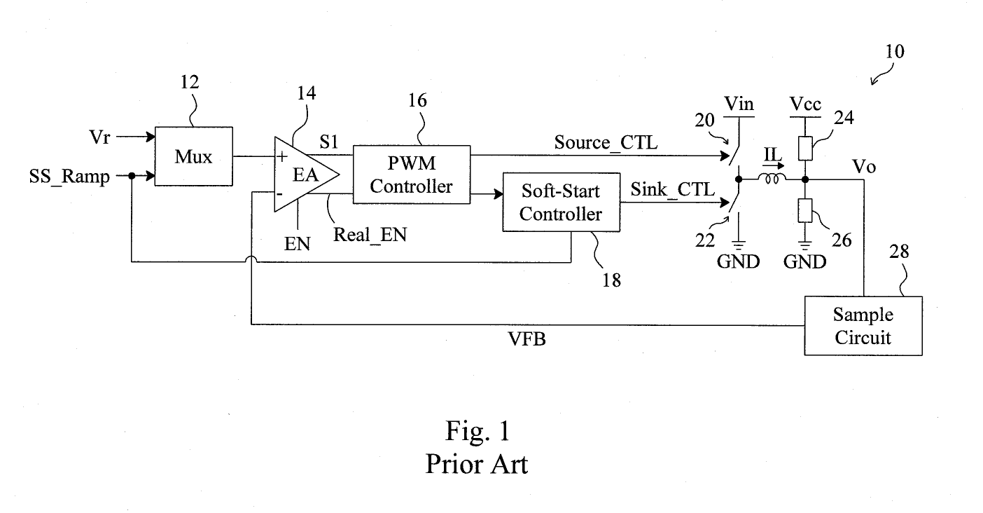

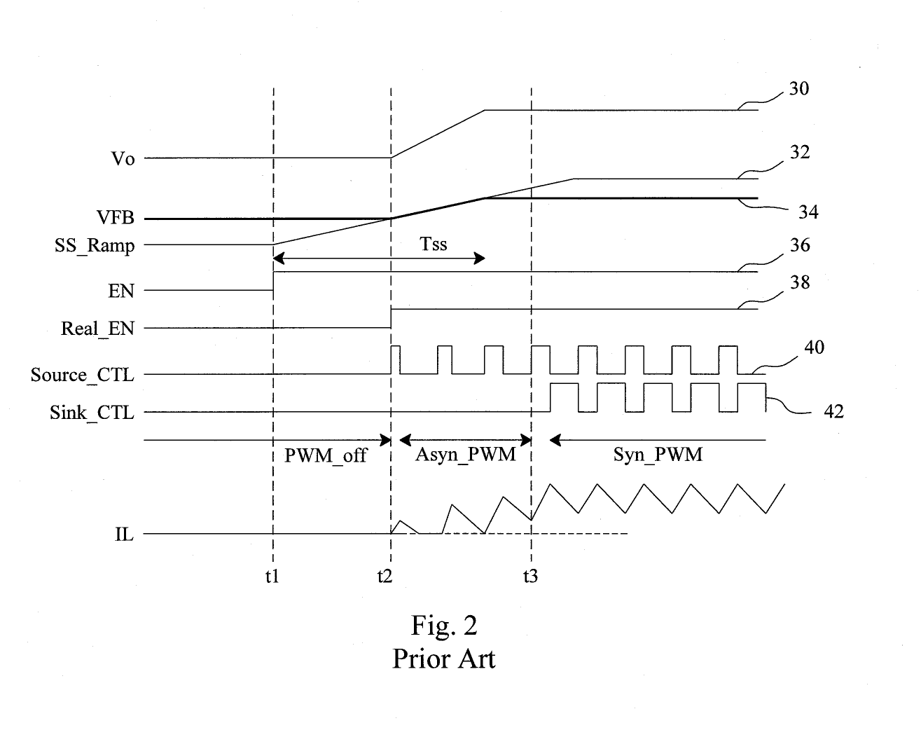

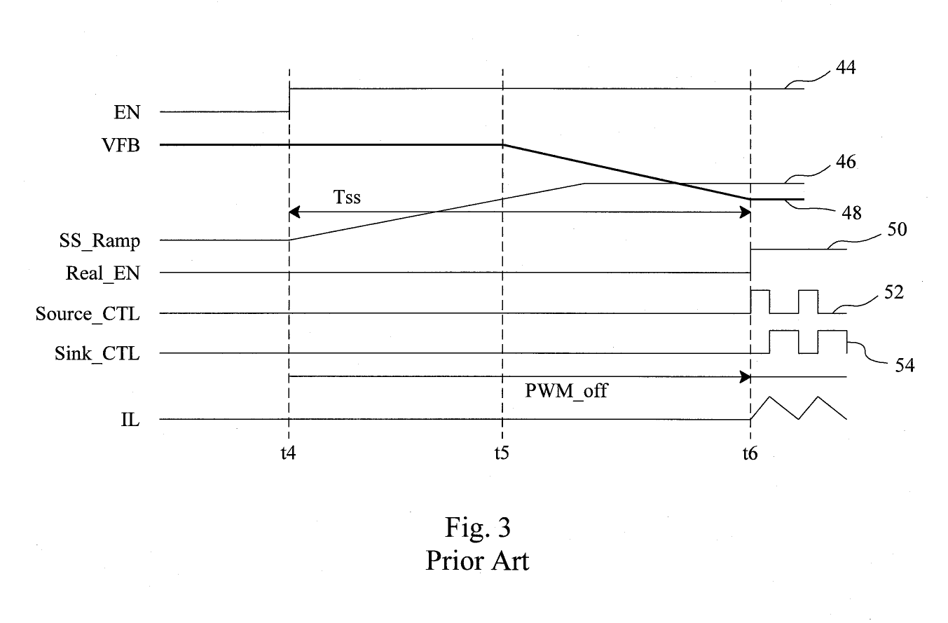

### DETAILED DESCRIPTION OF THE INVENTION

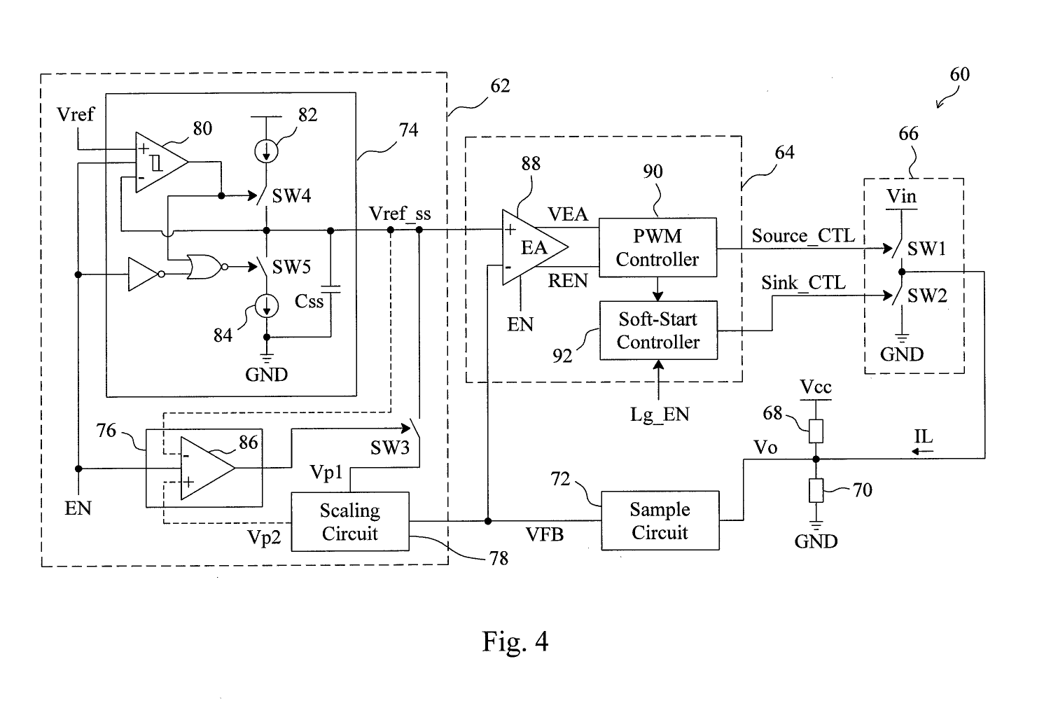

FIG. 4 is a circuit diagram of a first embodiment according to the present invention. In a switching regulator 60, an output stage 66 includes a pair of serially connected switches SW1 and SW2 switched by control signals Source_CTL and Sink_CTL, respectively, to convert an input voltage Vin into an output voltage Vo for loads 68 and 70, and a sample circuit 72 samples the output voltage Vo to generate a feedback signal VFB for a soft-start circuit 62 and a control circuit 64. The soft-start circuit 62 provides a ramp signal Vref_ss for the control circuit 64. In the control circuit 64, an error amplifier 88 generates an error signal VEA according to the ramp signal Vref_ss and the feedback signal VFB, a PWM controller 90 generates the control signals Source_CTL and Sink_CTL according to the error signal VEA, and a soft-start controller 92 blocks the control signal Sink_CTL to keep the switch SW2 off for a period of time during soft-start. In the soft-start circuit 62, a signal generator 74 provides the ramp signal Vref_ss during soft-start, for the output voltage V0 of the switching regulator 60 changing from the level of a residual voltage toward a target level. According to the feedback signal VFB, the scaling circuit 78 generates a scaling voltage Vp1 and a threshold Vp2 smaller than or equal to the scaling voltage Vp1. The scaling voltage Vp1 shifts the level of the ramp signal Vref_ss when triggering soft-start. Preferably, the scaling voltage Vp1 is equal to the feedback signal VFB. When triggering soft-start, the controller 76 turns on a switch SW3 for a period of time to provide the scaling voltage Vp1 for the signal generator 74. The controller 76 includes a comparator 86 for comparing the ramp signal Vref_ss with the threshold Vp2 and, when the ramp signal Vref_ss is greater than the threshold Vp2, turns off the switch SW3. In this embodiment, the signal generator 74 includes a capacitor Css, current sources 82 and 84 charge and discharge the capacitor Css, respectively, to generate the ramp signal Vref_ss, and a hysteresis comparator 80 to switch switches SW4 and SW5 according to the ramp signal Vref_ss and a reference voltage Vref, for charging or discharging the capacitor Css.

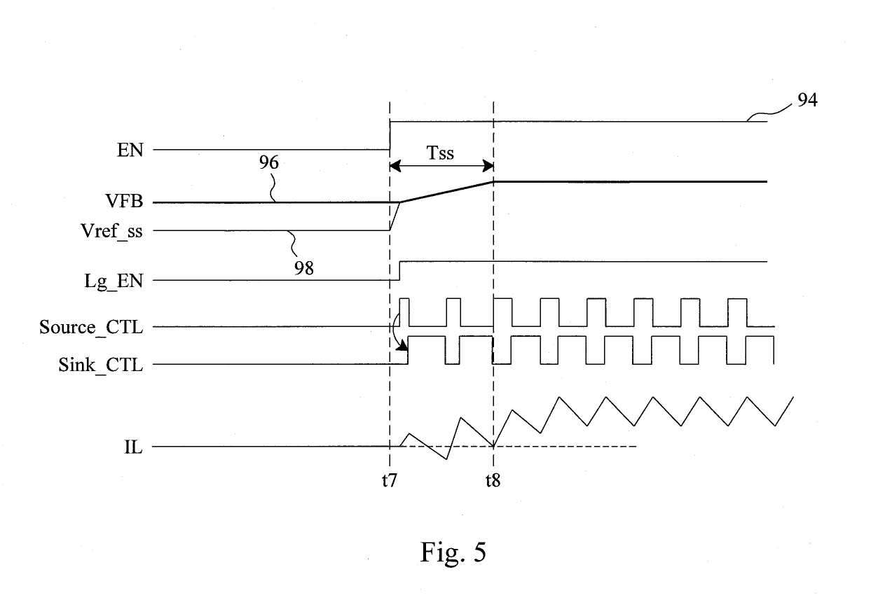

FIG. 5 is a waveform diagram of the switching regulator 60 shown in FIG. 4, for illustrating the soft-start operation of the switching regulator 60 when the residual voltage is lower than the target level, in which waveform 94 represents the enable signal EN, waveform 96 represents the feedback signal VFB, and waveform 98 represents the ramp signal Vref_ss. When the switching regulator 60 is started, the enable signal EN turns into high level to enable the soft-start circuit 62 to trigger soft-start, such as at time t7, as shown by the waveform 94. Since there is the residual voltage at the output of the switching regulator 60, the feedback signal VFB is not zero, as shown by the waveform 96. According to the feedback signal VFB, the scaling circuit 78 generates the scaling voltage Vp1 and the threshold Vp2. In this embodiment, the scaling voltage Vp1 and the threshold Vp2 are both equal to the feedback signal VFB. After being enabled, the controller 76 compares the ramp signal Vref_ss with the threshold Vp2. At this time, since the ramp signal Vref_ss is smaller than the threshold Vp2, the controller 76 turns on the switch SW3 to allow the scaling voltage Vp1 to charge the capacitor Css, and thereby raises the level of the ramp signal Vref_ss. When the ramp signal Vref_ss reaches the threshold Vp2, the controller 76 turns off the switch SW3. Because the ramp signal Vref_ss is now equal to the feedback voltage VFB, the error amplifier 88 immediately turns on an enable signal REN to enable the PWM controller 90. Then, the PWM controller 90 generates the control signals Source_CTL and Sink_CTL according to the error signal VEA to switch the switches SW1 and SW2, respectively, thereby making the output voltage V0 raise from the residual voltage toward the target level. In addition, since the ramp signal Vref_ss is smaller than the reference voltage Vref, the hysteresis comparator 80 in the signal generator 74 allows the current source 82 to charge the capacitor Css to increase the ramp signal Vref_ss. When the ramp signal Vref_ss reaches the level of the reference voltage Vref, such as at time t8, the soft-start ends and the ramp signal Vref_ss is fixed at the level of the reference voltage Vref.

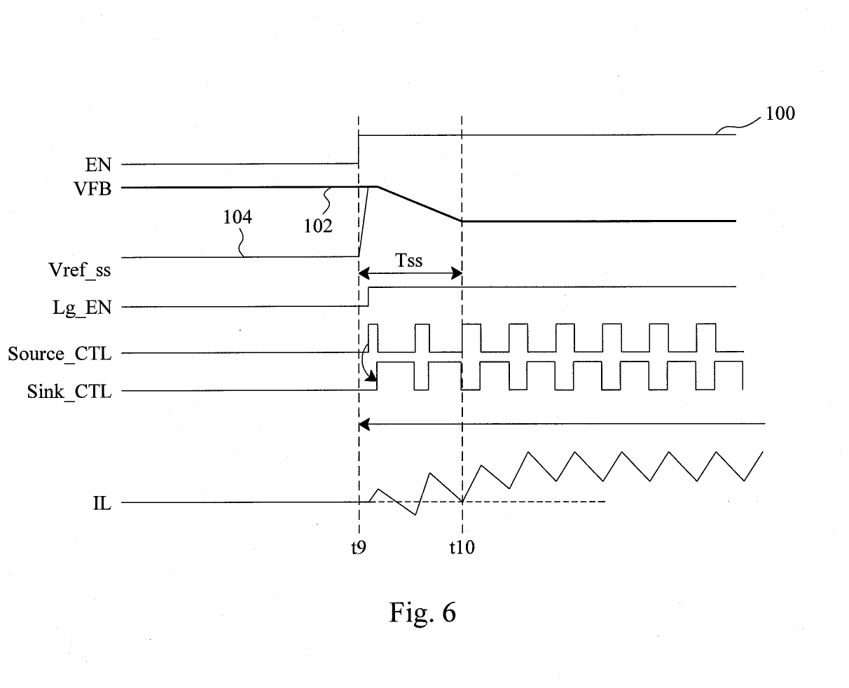

FIG. 6 is another waveform diagram of the switching regulator 60 shown in FIG. 4, for illustrating the soft-start operation of the switching regulator 60 when the residual voltage is higher than the target level, in which waveform 100 represents the enable signal EN, waveform 102 represents the feedback signal VFB, and waveform 104 represents the ramp signal Vref_ss. When the switching regulator 60 is started, the enable signal EN turns to high level to enable the soft-start circuit 62 to trigger soft-start, such as at time t9, as shown by the waveform 100. Since there is the residual voltage at the output of the switching regulator 60, the feedback signal VFB is not zero, as shown by the waveform 102. The scaling circuit 78 generates the scaling voltage Vp1 and the threshold Vp2 according to the feedback signal VFB. In this embodiment, the scaling voltage Vp1 and the threshold Vp2 are both equal to the feedback signal VFB. After being enabled, the controller 76 compares the ramp signal Vref_ss with the threshold Vp2. As the ramp signal Vref_ss is now smaller than the threshold Vp2, the controller 76 turns on the switch SW3 to allow the scaling voltage Vp1 to charge the capacitor Css, raising the level of the ramp signal Vref_ss. When the ramp signal Vref_ss reaches the threshold Vp2, the controller 76 turns off the switch SW3. Because the ramp signal Vref_ss is now equal to the level of the feedback voltage VFB, the error amplifier 88 immediately turns on the enable signal REN to enable the PWM controller 90. Then, the PWM controller 90 generates the control signals Source_CTL and Sink_CTL according to the error signal VEA to switch the switches SW1 and SW2, respectively, making the output voltage Vo decrease from the level of the residual voltage toward the target level. In addition, the ramp signal Vref_ss is greater than the reference voltage Vref, so the hysteresis comparator 80 in the signal generator 74 allows the current source 84 to discharge the capacitor Css to decrease the ramp signal Vref_ss. When the ramp signal Vref_ss reaches the level of the reference voltage Vref, such as at time t10, the soft-start ends and the ramp signal Vref_ss is fixed at the level of the reference voltage Vref.

When the switching regulator 60 is started, according to the residual voltage at the output of the switching regulator 60, the soft-start circuit 62 first draws the ramp signal Vref_ss to a level close to the feedback signal VFB, so there is no need to wait for the ramp signal Vref_ss to gradually increase to the level of the feedback signal VFB, thereby effectively shortening the soft-start time Tss. Since there is only needed a signal generator for generating the ramp signal Vref_ss going upward or downward, the consumed circuit area can be reduced.

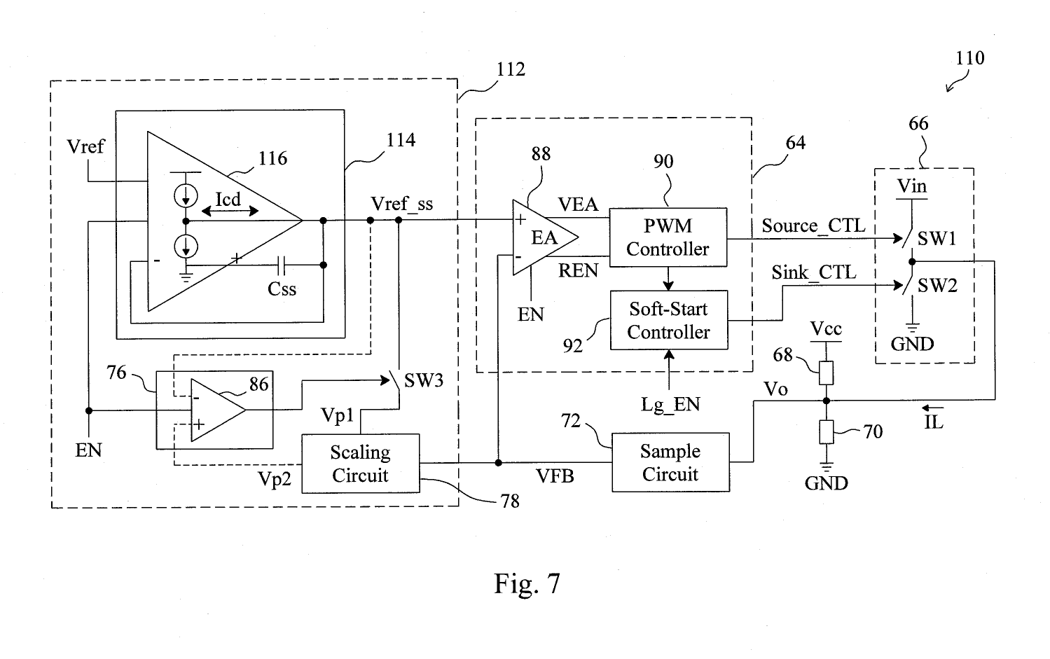

FIG. 7 is a circuit diagram of a second embodiment according to the present invention, in which the control circuit 64, the output stage 66 and the sample circuit 72 are identical to those described in the embodiment of FIG. 4. In this switching regulator 110, in addition to the controller 76, the switch SW3, and the scaling circuit 78, a soft-start circuit 112 includes a signal generator 114 to provide a ramp signal Vref_ss during soft-start, such that the output voltage Vo of the switching regulator 110 changes from a residual voltage toward a target level. The signal generator 114 includes a capacitor Css and a voltage-current converter 116. The voltage-current converter 116 generates a current Icd according to the difference between a reference voltage Vref and the ramp signal Vref_ss, to charge or discharge the capacitor Css to generate the ramp signal Vref_ss. When the switching regulator 110 is started, an enable signal EN enables the soft-start circuit 112. At this time, the scaling circuit 78 generates a scaling voltage Vp1 and a threshold Vp2 according to the feedback signal VFB. The controller 76 compares the ramp signal Vref_ss with the threshold Vp2. If the ramp signal Vref_ss is smaller than the threshold Vp2, the controller 76 turns on the switch SW3 to allow the scaling voltage Vp1 to charge the capacitor Css, making the ramp signal Vref_ss raise to the level of the scaling voltage Vp1, thereby shortening the soft-start time. When the reference voltage Vref is greater than the ramp signal Vref_ss, the voltage-current converter 116 provides a current Icd to charge the capacitor Css to increase the ramp signal Vref_ss. When the reference voltage Vref is smaller than the ramp signal Vref_ss, the voltage-current converter 116 provides a current Icd to discharge the capacitor Css to decrease the ramp signal Vref_ss.

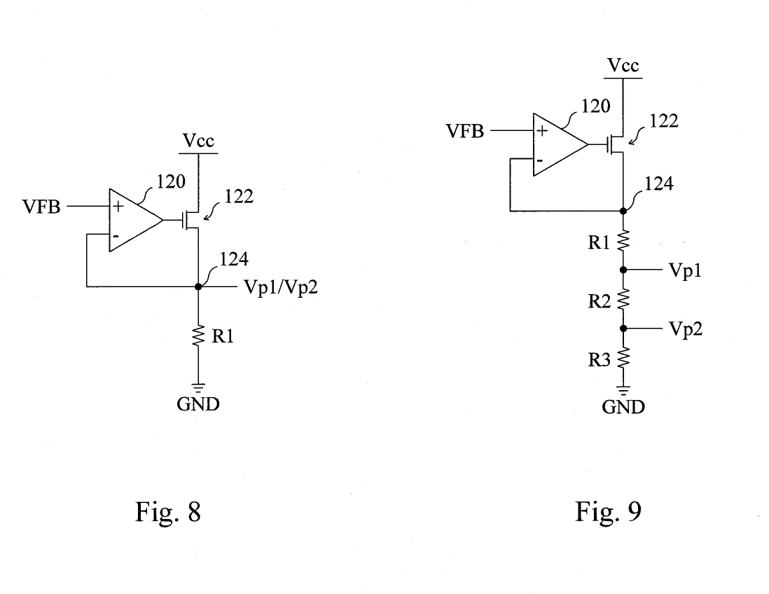

FIG. 8 is a circuit diagram of an embodiment for the scaling circuit 78, which includes an operational amplifier 120, a MOS transistor 122, and a resister R1. The MOS transistor 122 and the resister R1 are connected in series between a voltage terminal Vcc and a ground terminal GND. The operational amplifier 120 has a positive input to receive the feedback signal VFB, a negative input connected to a node 124, and an output connected to a gate of the MOS transistor 122. The scaling voltages Vp1 and Vp2 are provided from the node 124. According to the principle of virtual short circuit, the feedback signal VFB at the positive input of the operational amplifier 120 will be equal to the scaling voltage Vp1 or the threshold Vp2 at the node 124. FIG. 9 is a circuit diagram of another embodiment for the scaling circuit 78. Similar to FIG. 8, it also includes an operational amplifier 120 and an MOS transistor 122. The MOS transistor 122 is connected with resisters R1, R2 and R3 in series between a voltage terminal Vcc and a ground terminal GND. According to the principle of virtual short circuit, the voltage at the node 124 is equal to the feedback signal VFB. The resisters R1, R2 and R3 divide the feedback signal VFB to generate the scaling voltage Vp1 and the threshold Vp2.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A soft-start circuit for a switching regulator, comprising:
a signal generator operative to provide a ramp signal during soft-start such that an output voltage of the switching regulator changes from a residual voltage toward a target level; and
a scaling circuit coupled to the signal generator, operative to provide a scaling voltage depending on the residual voltage, to shift a level of the ramp signal when the soft-start is triggered.

2. The soft-start circuit of claim 1, further comprising:
a switch connected between the signal generator and the scaling circuit; and
a controller connected to the switch, operative to turn on the switch when the soft-start is triggered, to allow the scaling voltage to apply to the signal generator.

3. The soft-start circuit of claim 2, wherein the controller comprises a comparator operative to compare the ramp signal with a threshold, to turn on the switch when the ramp signal is smaller than the threshold and to turn off the switch when the ramp signal is equal to the threshold.

4. The soft-start circuit of claim 3, wherein the threshold is provided by the scaling circuit.

5. The soft-start circuit of claim 1, wherein the signal generator comprises:
a capacitor;
two current sources connected to the capacitor, operative to charge and discharge the capacitor, respectively, to generate the ramp signal; and
a hysteresis comparator connected to the two current sources, operative to control the two current sources to charge or discharge the capacitor according to a reference voltage and the ramp signal.

6. The soft-start circuit of claim 5, wherein the scaling circuit provides the scaling voltage to charge the capacitor to shift the level of the ramp signal when the soft-start is triggered.

7. The soft-start circuit of claim 1, wherein the signal generator comprises:
a capacitor; and
a voltage-current converter connected to the capacitor, operative to generate a current to charge or discharge the capacitor according to a difference between a reference voltage and the ramp signal extracted from the capacitor, to generate the ramp signal.

8. The soft-start circuit of claim 7, wherein the scaling circuit provides the scaling voltage to charge the capacitor when the soft-start is triggered, to shift the level of the ramp signal.

9. The soft-start circuit of claim 7, wherein the ramp signal has a start level equal to a level of the scaling voltage.

10. A soft-start method for a switching regulator, comprising the steps of:
(A) providing a ramp signal when soft-start is triggered, such that an output voltage of the switching regulator changes from a residual voltage toward a target level;
(B) generating a scaling voltage according to the residual voltage; and
(C) shifting a level of the ramp signal with the scaling voltage.

11. The soft-start method of claim 10, wherein the step (A) comprises the step of charging or discharging a capacitor according to a reference voltage and the ramp signal, to generate the ramp signal.

12. The soft-start method of claim 11, wherein the step (C) comprises the step of providing the scaling voltage to charge the capacitor to shift the level of the ramp signal.

13. The soft-start method of claim 12, wherein the step (C) further comprises the step of providing the scaling voltage to charge the capacitor when the ramp signal is smaller than a threshold, until the ramp signal becomes equal to the threshold.

14. The soft-start method of claim 10, wherein the step (A) comprises the steps of:
generating a current according to a difference between a reference voltage and the ramp signal; and
charging or discharging a capacitor with the current to generate the ramp signal.

15. The soft-start method of claim 14, wherein the step (C) comprises the step of providing the scaling voltage to charge the capacitor to shift the level of the ramp signal.

16. The soft-start method of claim 15, wherein the step (C) further comprises the step of providing the scaling voltage to charge the capacitor when the ramp signal is smaller than a threshold, until the ramp signal becomes equal to the threshold.

17. The soft-start method of claim 10, wherein the step (C) comprises the step of setting a start level of the ramp signal equal to a level of the scaling voltage.
